(19) United States
(12) Patent Application Publication
(10) Pub. No.: US 2010/0088368 A1
(43) Pub. Date: Apr. 8, 2010

(54) IMAGE SERVER APPARATUS AND IMAGE CLIENT APPARATUS

(75) Inventors: Toshimizu Yamane, Tokyo (JP); Takashi Oya, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/572,161

(22) Filed: Oct. 1, 2009

(30) Foreign Application Priority Data
Oct. 3, 2008 (JP) 2008-258539

(51) Int. Cl. G06F 15/16

(52) U.S. Cl. 709/203; 382/305

(57) ABSTRACT

There is provided an image server apparatus which determines whether there is image data to which meta information requested from an image client apparatus communicable through a network is not provided, executes the process to generate the meta information if there is the image data to which the meta information is not provided, as a result of the determination, and transmits the generated meta information to the image client apparatus.

### BACKGROUND OF THE INVENTION

1. Field of the Invention

The present invention relates to an image server apparatus, an image client apparatus, an image transmission and reception system, and an information processing method.

2. Description of the Related Art

In recent years, the digitalization of an image capturing device, reduction in the cost of recording media such as a hard disk and a flash memory, and increase in the capacity thereof has enabled even an individual to easily store a large amount of image contents. When a user wants to retrieve a desired image from a large amount of image contents, the user needs to perform searching, sorting, and listing based on meta information extracted from an image.

As an example of the meta information, there has been a standardized system that records photographing date and camera settings at the time of photographing in a header of an image as the exchangeable image file format version 2.1 (Exif2.1). A mechanism for transferring the meta information has also been standardized in the digital item declaration language-lite (DIDL-Lite) used in content directory service (CDS) of universal plug and play (UPnP).

As a technique for providing the meta information to an image, Japanese Patent Application Laid-Open No. 2006-99268 discusses a technique in which a load in providing the meta information is dispersed to a server apparatus for providing the meta information to perform an efficient search. Japanese Patent Application Laid-Open Nos. 2002-342218 and 2006-146932 discuss technique for generating a reduced image for thumbnail corresponding to a display apparatus with various resolutions in relation to the distribution of an image to a cellular phone.

However, the meta information normally provided after photographing includes photographing date and photographing condition at most. Only thumbnail is provided as information on image contents. For this reason, a user needs to manually provide the meta information after capturing an image so as to perform searching and sorting using an advanced type of the meta information related to the image contents such as facial information and scene information. If the user manually needs to provide the meta information after capturing an image, it is a big problem that burdens the user with a load of inputting information.

Moreover, in a conventional technique, since a server apparatus for supplying contents is not provided with a meta information calculating function, the meta information needs calculating after image data is transferred to other apparatus, which compresses a communication band as a consequence.

### SUMMARY OF THE INVENTION

The present invention is directed to a server capable of automatically generating the meta information requested by a client.

According to an aspect of the present invention, an image server apparatus includes: a determination unit configured to determine whether there is image data to which meta information requested from an image client apparatus is not provided; a generation unit configured to generate the meta information if there is the image data to which the meta information is not provided as a result of the determination by the determination unit; and a transmission unit configured to transmit the generated meta information to the image client apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of an image transmission and reception system and a hardware configuration of each apparatus constituting the image transmission and reception system in a first exemplary embodiment.

FIG. 2 is a chart describing an example of the sequence in which the communication apparatus for the display apparatus obtains meta information from the communication apparatus for the photographing apparatus.

FIG. 3 illustrates an example of a meta information acquisition notice.

FIG. 4 illustrates an example of a meta information acquisition request.

FIG. 5 is a chart describing an example of the sequence in which the communication apparatus for the display apparatus obtains from the communication apparatus for the photographing apparatus another type of meta information which is not included in the meta information acquisition notice issued before the image communication is conducted, after the image communication is started.

FIG. 6 is a chart describing an example of the sequence in which meta information is provided for image data newly stored in the communication apparatus for the photographing apparatus.

FIG. 7 is a flow chart for a process executed in the communication apparatus for the display apparatus and illustrating an example of the process for setting the type of meta information which may be requested.

FIG. 8 is a flow chart for a process executed in the communication apparatus for the photographing apparatus and illustrating an example of the process for storing the meta information generation request.

FIG. 9 is a flow chart for a process executed in the communication apparatus for the photographing apparatus and illustrating an example of the process from start to end of the generation of meta information.

FIG. 10 is a flow chart for a process executed in the communication apparatus for the photographing apparatus and illustrating an example of a meta information generation process.

FIG. 11 is a flow chart for a process executed in the communication apparatus for the photographing apparatus and illustrating an example of a program existence confirmation process.

FIG. 12 illustrates an example of a request for acquiring the program.

FIG. 13 is a flow chart for a process executed in the communication apparatus for the display apparatus and illustrating an example of the process from the start to the end of searching, sorting, and listing.

FIG. 14 is a flow chart for a process executed in the communication apparatus for the photographing apparatus and illustrating an example of a meta information transmission process.

FIG. 15 is a flow chart for a process executed in the communication apparatus for the photographing apparatus and illustrating an example of the process for storing new image data in a storage area.

FIG. 16 is a flow chart for a process executed in the communication apparatus for the photographing apparatus and illustrating an example of the meta information generation process for new image data.

FIG. 17 is a flow chart for a process executed in the communication apparatus for the display apparatus and illustrating an example of the process from the start to the end of the browsing of meta information.

FIG. 18 is a flow chart for a process executed in the communication apparatus for the photographing apparatus and illustrating an example of the process for storing a renewed meta information generation request.

FIG. 19 is a block diagram illustrating an example of the system configuration of an image transmission and reception system and the hardware configuration of each apparatus constituting the image transmission and reception system according to a second exemplary embodiment.

FIG. 20 is a block diagram illustrating an example of the system configuration of an image transmission and reception system and the hardware configuration of each apparatus constituting the image transmission and reception system according to a third exemplary embodiment.

FIG. 21 is a block diagram illustrating an example of the system configuration of an image transmission and reception system and the hardware configuration of each apparatus constituting the image transmission and reception system according to a fourth exemplary embodiment.

FIG. 22 is a block diagram illustrating an example of the system configuration of an image transmission and reception system and the hardware configuration of each apparatus constituting the image transmission and reception system according to a fifth exemplary embodiment.

### DESCRIPTION OF THE EMBODIMENTS

Various exemplary embodiments, features, and aspects of the present invention will now be described in detail below with reference to the drawings. It is to be noted that the relative arrangement of the components, the numerical expressions, and numerical values set forth in these embodiments are not intended to limit the scope of the present invention.

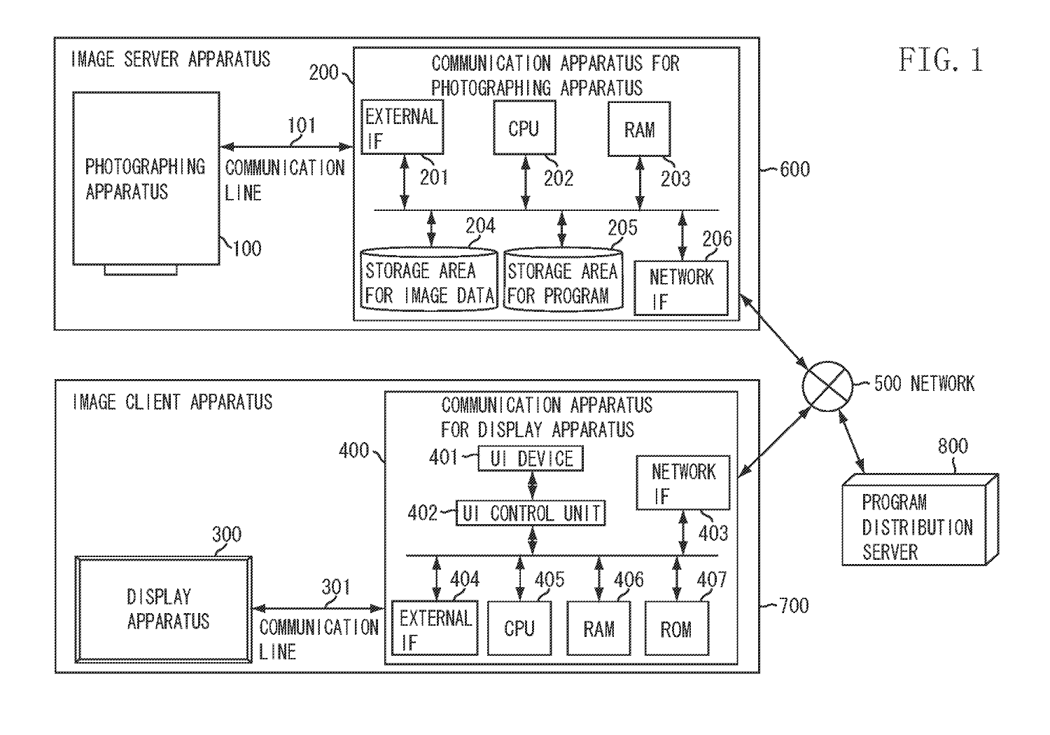

FIG. 1 illustrates an example of a system configuration of an image transmission and reception system and a hardware configuration of each apparatus forming the image transmission and reception system in a first exemplary embodiment.

As illustrated in FIG. 1, the image transmission and reception system of the present exemplary embodiment includes an image server apparatus 600, an image client apparatus 700, and a program distribution server 800. Each apparatus can communicate with each other through a network 500.

The image server apparatus 600 includes a communication apparatus for a photographing apparatus 200 and a photographing apparatus 100 communicable with the communication apparatus for the photographing apparatus 200. The image client apparatus 700 includes a communication apparatus for a display apparatus 400 and a display apparatus 300. The image server apparatus according to the claim is the image server apparatus 600 or the communication apparatus for the photographing apparatus 200, for example. The image client apparatus according to the claim is the image client apparatus 700 or the communication apparatus for the display apparatus 400, for example.

The communication apparatus for the photographing apparatus 200 is connected with the photographing apparatus 100 through a communication line 101 from an external IF 201. As an example of a connection method, a universal serial bus (USB) is available, but the present invention does not depend on a specific connection method. The communication apparatus for the photographing apparatus 200 is also connected with the network 500 from a network IF 206. The network 500 is connected with the communication apparatus for the display apparatus 400 and the program distribution server 800.

A storage area for image data 204 and a storage area for a program 205 exist within the communication apparatus for the photographing apparatus 200. More specifically, these areas can be realized by using a hard disk or a flash memory, but the present invention does not depend on a specific storage medium. A CPU 202 and a RAM 203 exist in the communication apparatus for the photographing apparatus 200. The program read from the storage area for the program 205 to the RAM 203 is interpreted and executed by the CPU 202 to enable performing various controls in the apparatus and calculating the meta information.

The communication apparatus for the display apparatus 400 is connected with the display apparatus 300 through a communication line 301 from an external IF 404. As an example of a connection method, a high-definition multimedia interface (HDMI) is available, but the present invention does not depend on a specific connection system. The communication apparatus for the display apparatus 400 is also connected with the network 500 from a network IF 403. A UI device 401 (i.e., a user interface) is connected to the communication apparatus for the display apparatus 400. More specifically, a light emitting diode and a liquid crystal panel which display the state of the apparatus or the contents of processing, and a remote control and various buttons which provide operation instructions for the apparatus are connected to the communication apparatus for the display apparatus 400. A CPU 405, a RAM 406, and a ROM 407 exist within the communication apparatus for the display apparatus 400. The program read from ROM 407 to the RAM 406 is interpreted and executed by the CPU 405 to enable performing various controls in the apparatus, obtaining the meta information, and displaying the meta information to the user.

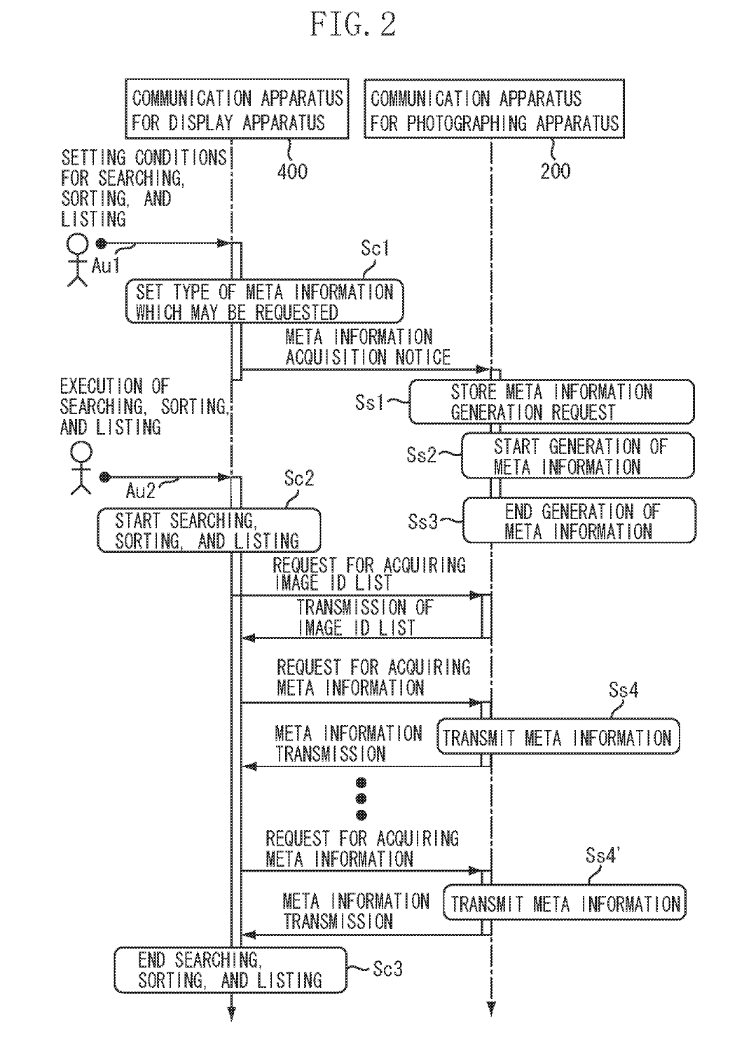

With reference to FIG. 2, here is described below the sequence will be described in which the communication apparatus for the display apparatus 400 obtains the meta information from the communication apparatus for the photographing apparatus 200. FIG. 2 is a chart describing an example of the sequence in which the communication apparatus for the display apparatus 400 obtains meta information from the communication apparatus for the photographing apparatus 200. Although the sequence for searching and sorting using the meta information or for listing or browsing the meta information is described below, the object of obtaining the meta information is not limited to the above. In the exemplary embodiment, the meta information is obtained in a 2-stage process flow.

Before performing an image communication, first, a method of transmitting the type of meta information required for display from the image client apparatus 700 to the image server apparatus 600 is described. Secondly, a method of transmitting the generated meta information from the image server apparatus 600 to the image client apparatus 700 is described. The term “image communication” refers to communication in which the image ID illustrated in FIG. 2, for example, is transmitted from the image server apparatus 600 to the image client apparatus 700 or the meta information is transmitted from the image server apparatus 600 to the image client apparatus 700.

The first-stage process flow from steps Sc1 to Ss3 is described first. In the flow of Sc1 to Ss3, the type of meta information which may be requested by the communication apparatus for the display apparatus 400 is previously taken as a meta information acquisition notice and transmitted to the communication apparatus for the photographing apparatus 200. If the type of meta information yet to be generated is included in the meta information acquisition notice, the communication apparatus for the photographing apparatus 200 starts generating meta information of the type of the meta information. In FIG. 2, a user sets conditions for searching, sorting, and listing the meta information at Au1. In step Sc1, the communication apparatus for the display apparatus 400 sets the type of meta information which may be requested, as the meta information acquisition notice to the RAM 406 based on the conditions (the type of meta information) set by the user and transmits the meta information acquisition notice to the communication apparatus for the photographing apparatus 200.

More specifically, the communication apparatus for the display apparatus 400 transmits the meta information acquisition notice to the communication apparatus for the photographing apparatus 200 before the image communication is started (in other words, before a meta information acquisition request is transmitted).

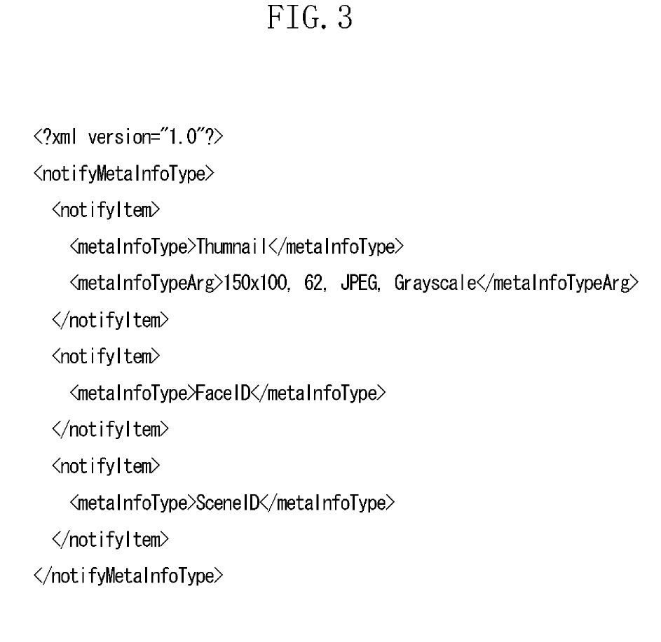

The meta information acquisition notice is expressed in an extensible markup language (XML) format illustrated in FIG. 3 and a set of the type of meta information and attribute information attached to the type of meta information is described in a list form. FIG. 3 illustrates an example of the meta information acquisition notice. If the meta information is a thumbnail image, image size, image quality, image format, or color conversion parameter is described in the attribute information as thumbnail information. The user explicitly sets the conditions in this case. However, the conditions for searching, sorting, and listing the meta information may also be set by the communication apparatus for the display apparatus 400 at the time of start.

In step Ss1, the communication apparatus for the photographing apparatus 200 which has received the meta information acquisition notice (the meta information acquisition notice reception) extracts the type of meta information which has not been provided to the image data in the storage area for the image data 204, from the meta information acquisition notice. The communication apparatus for the photographing apparatus 200 stores the type of meta information as a meta information generation request in the RAM 203. In step Ss2, the communication apparatus for the photographing apparatus 200 calculates (generates) the meta information based on the meta information generation request. In step Ss3, the communication apparatus for the photographing apparatus 200 stores the meta information in the storage area for the image data 204.

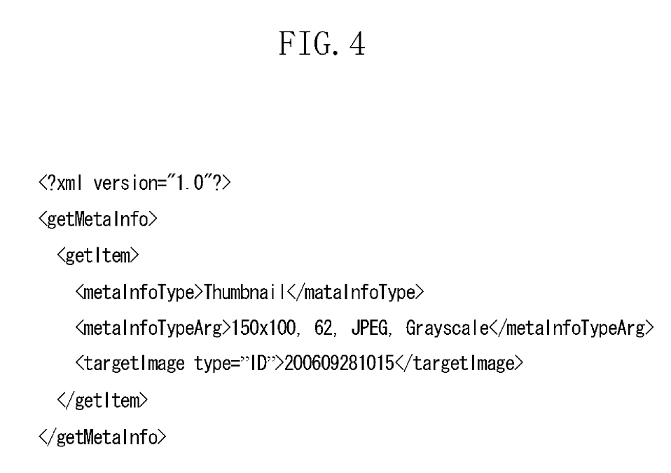

The second-stage process flow from steps Sc2 to Sc3 is described. In the flow of Sc2 to Sc3, the communication apparatus for the display apparatus 400 transmits the meta information acquisition request to the communication apparatus for the photographing apparatus 200 and the communication apparatus for the photographing apparatus 200 transmits the generated meta information. In FIG. 2, the user gives instructions for execution of searching, sorting, and listing at Au2. In step Sc2, the communication apparatus for the display apparatus 400 starts searching, sorting, and listing processes and obtains image IDs of all image data to be processed as a list from the communication apparatus for the photographing apparatus 200. The communication apparatus for the display apparatus 400 transmits the meta information acquisition request to the communication apparatus for the photographing apparatus 200. The meta information acquisition request is expressed in the XML format illustrated in FIG. 4 and, the type of meta information and attribute information desired to be obtained and an image ID are described therein. FIG. 4 illustrates an example of the meta information acquisition request. In step Ss4, the communication apparatus for the photographing apparatus 200 which has received the meta information acquisition request (the meta information acquisition request reception) reads the generated meta information from the storage area for the image data 204 and transmits the meta information to the communication apparatus for the display apparatus 400. As illustrated in steps Ss4 to Ss4′, the meta information acquisition request is transmitted twice or more from the communication apparatus for the display apparatus 400 and the meta information is accordingly transmitted twice or more from the communication apparatus for the photographing apparatus 200.

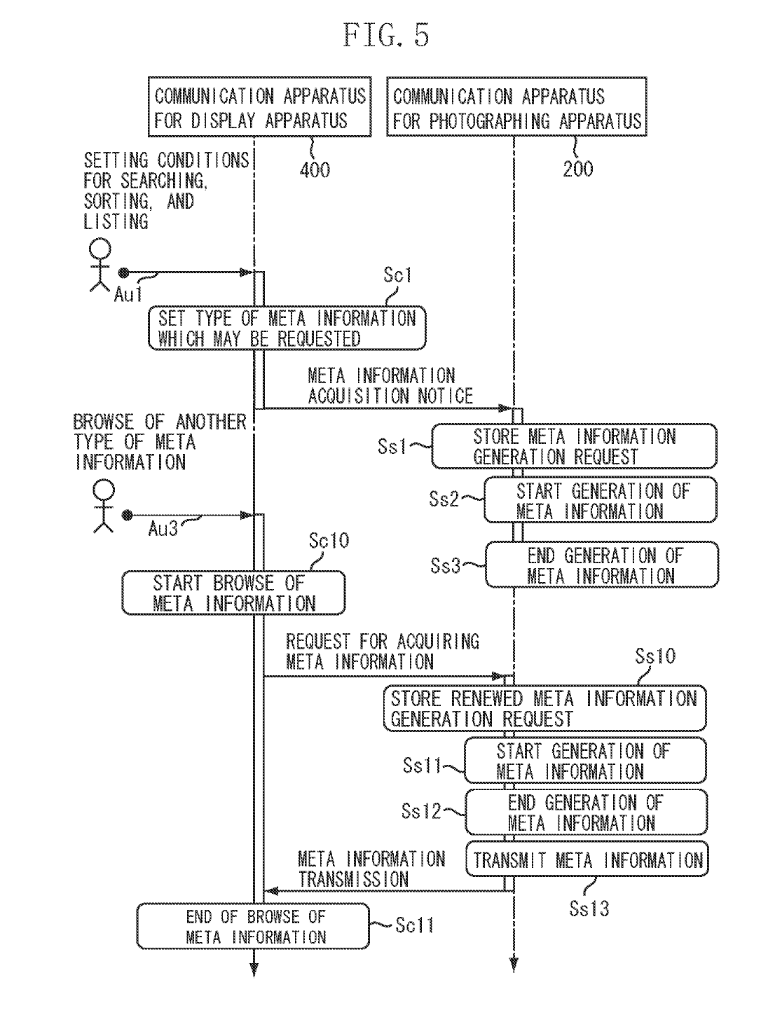

With reference to FIG. 5, the sequence is described below in which the communication apparatus for the display apparatus 400 obtains another type of meta information which is not included in the meta information acquisition notice issued before the image communication, from the communication apparatus for the photographing apparatus 200 after the image communication is started. This occurs in the case where the meta information acquisition request is newly added according to the operation of the user. FIG. 5 is a chart describing an example of the sequence in which the communication apparatus for the display apparatus 400 obtains another type of meta information which is not included in the meta information acquisition notice issued before the image communication, from the communication apparatus for the photographing apparatus 200, after the image communication is started.

The following description presumes that the meta information acquisition notice is previously transmitted to the communication apparatus for the photographing apparatus 200 at Au1. However, even if the meta information acquisition notice is not received, the sequence is similar at Au3 and thereafter.

The first-stage process flow starting at Au1 is similar to that in FIG. 2, so that the second-stage process flow is described. When the user designates the browsing of another type of meta information which is not included in the meta information acquisition notice at Au3, in step Sc10, the communication apparatus for the display apparatus 400 starts a meta information browsing process and transmits the meta information acquisition request to the communication apparatus for the photographing apparatus 200. In step Ss10, if the type of meta information which is not provided to the image data in the storage area for the image data 204, is included in the meta information acquisition request, the communication apparatus for the photographing apparatus 200 which has received the meta information acquisition request renews the meta information generation request and stores it in the RAM 203. In steps Ss11 and Ss12, the communication apparatus for the photographing apparatus 200 generates the meta information based on the meta information generation request. In step Ss13, the communication apparatus for the photographing apparatus 200 transmits the meta information to the communication apparatus for the display apparatus 400.

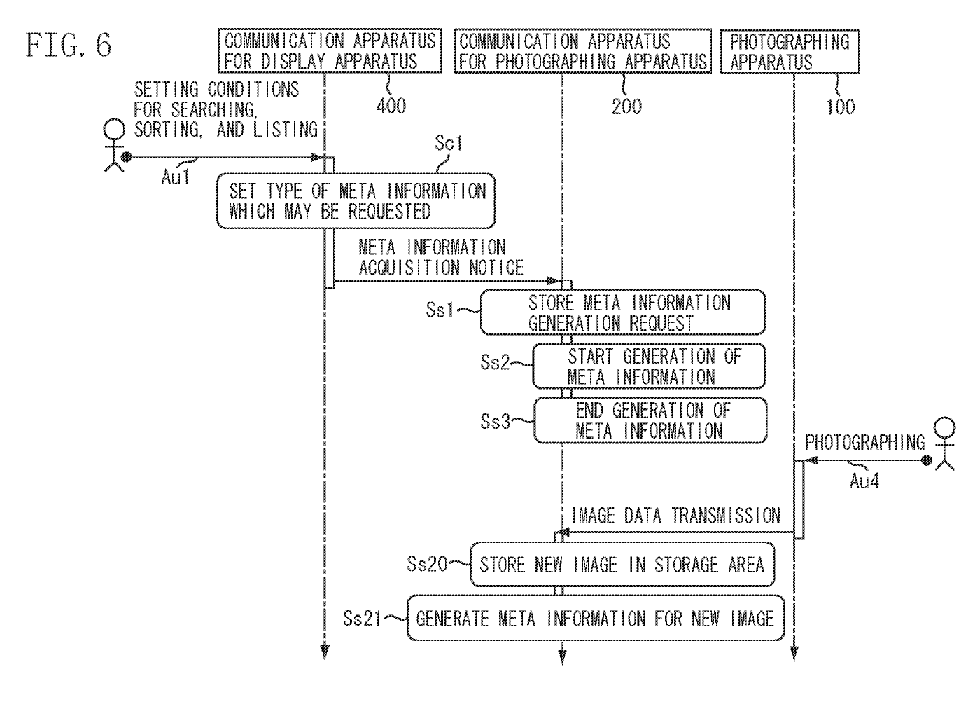

Next, with reference to FIG. 6, the sequence is described in which the meta information is provided to image data newly stored in the communication apparatus for the photographing apparatus 200. This corresponds to the case where the meta information is provided to the image (image data) taken by the photographing apparatus 100 at timing that the meta information is copied on the communication apparatus for the photographing apparatus 200. FIG. 6 is a chart describing an example of the sequence in which the meta information is provided to image data to be newly stored in the communication apparatus for the photographing apparatus 200.

While in the following description, the storage of new image data acquired in image capturing is described as an example, new image data acquired in other ways may also be stored.

The first-stage process flow starting at Au1 is similar to that in FIG. 2, so that the second-stage process flow is described. When the user captures an image at Au4, the photographing apparatus 100 transmits image data to the communication apparatus for the photographing apparatus 200 through the communication line 101. In step Ss20, the communication apparatus for the photographing apparatus 200 which has received the image data stores the new image data in the storage area for the image data 204. In step Ss21, the communication apparatus for the photographing apparatus 200 generates the meta information for the new image data.

Each process step in each sequence is described in detail below with reference to a flow chart. The top of each flow chart indicates the definition of an input-output parameter or an internal variable using a hexagonal box.

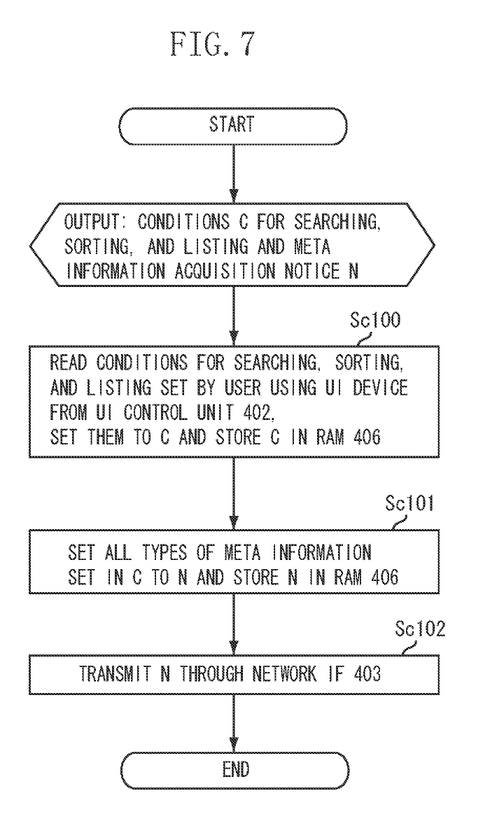

FIG. 7 is a flow chart for a process executed in the communication apparatus for the display apparatus 400. The flow chart illustrates an example of the process for setting the type of meta information which may be requested. The process describes step Sc1 in FIG. 2 in detail. As the conditions for searching, sorting, and listing, the type of meta information, a retrieval expression, and sorting order to be used are represented in a list form.

In step Sc100, the CPU 405 reads the conditions for searching, sorting, and listing which the user sets using the UI device 401 from the UI control unit 402, sets them to the conditions C for searching, sorting, and listing and stores the conditions C in the RAM 406.

In step Sc101, the CPU 405 sets all the types of meta information set in the conditions C to the meta information acquisition notice N and stores the meta-information acquisition notice N in the RAM 406 (meta-information acquisition notice generation).

In step Sc102, the CPU 405 transmits the meta information acquisition notice N to the communication apparatus for the photographing apparatus 200 through the network IF 403 (meta information acquisition notice transmission).

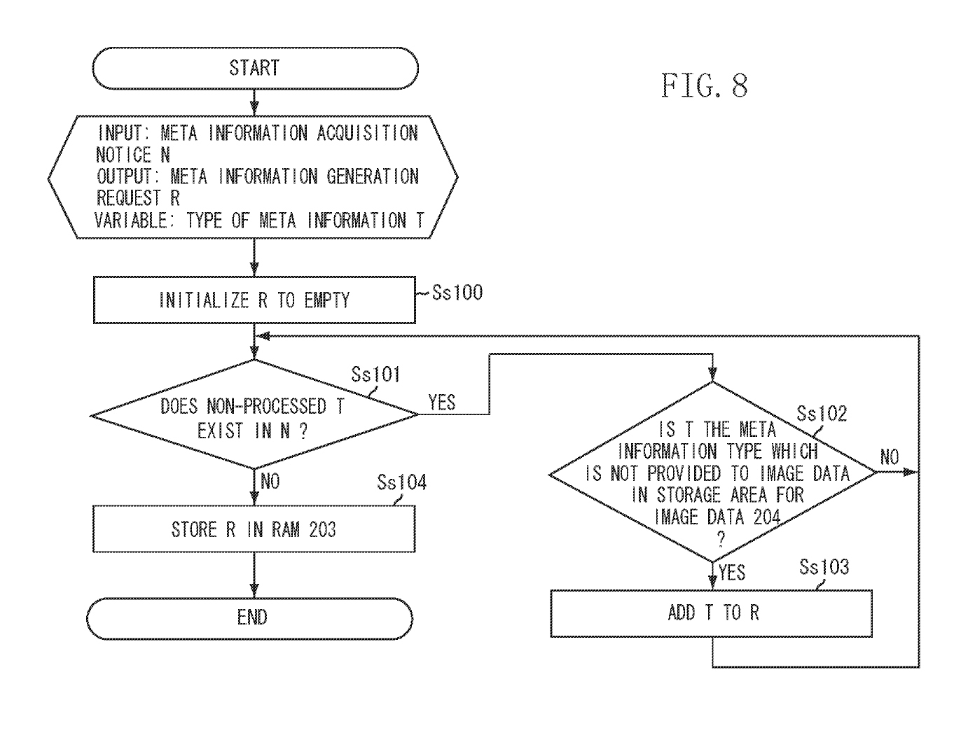

FIG. 8 is a flow chart for a process executed in the communication apparatus for the photographing apparatus 200. The flowchart illustrates an example of the process for storing the meta information generation request. The process describes step Ss1 in FIG. 2 in detail. In the meta information generation request, the type of meta information which needs to be generated is represented in a list form.

In step Ss100, the CPU 202 initializes the meta information generation request R to be empty. In step Ss101, the CPU 202 determines whether the type of meta information T yet to be processed exists in the meta-information acquisition notice N. If the type of meta information T yet to be processed exists in the meta information acquisition notice N (YES in step Ss101), the CPU 202 advances to step Ss102. If the type of meta information T yet to be processed does not exist in the meta information acquisition notice N (NO in step Ss101), the CPU 202 advances to step Ss104.

In step Ss102, the CPU 202 determines whether the type of meta information T yet to be processed is the type of meta information which is not provided to the image data in the storage area for the image data 204. If the type of meta information T yet to be processed is the type of meta information which is not provided to the image data in the storage area for the image data 204 (YES in step Ss102), the CPU 202 advances to step Ss103. If the type of meta information T yet to be processed is not the type of meta information which is not provided to the image data in the storage area for the image data 204 (NO in step Ss102), the CPU 202 returns to step Ss101.

In step Ss103, the CPU 202 adds the type of meta information T yet to be processed to the meta information generation request R.

In step Ss104, the CPU 202 stores the meta information generation request R in the RAM 203.

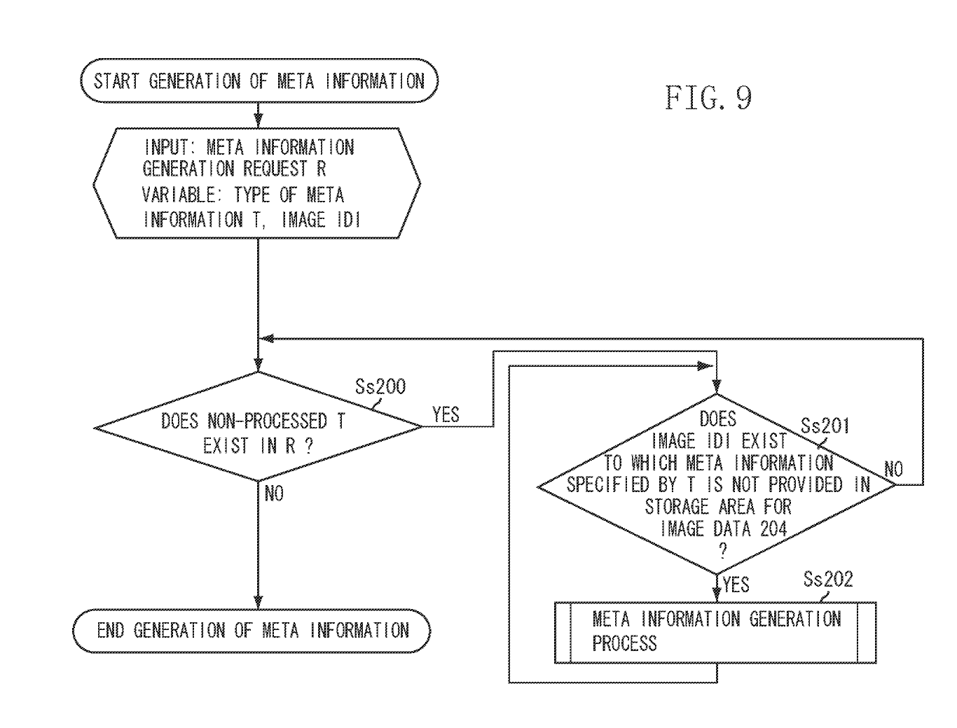

As described above, the process illustrated in FIG. 8 generates the meta information generation request R, stores it in the RAM 203, and starts a meta information generation process illustrated in FIG. 9.

FIG. 9 is a flow chart for a process executed in the communication apparatus for the photographing apparatus 200 and illustrating an example of the process from start to end of the generation of meta information. The process describes steps Ss2 to Ss3 in FIG. 2 in detail. The term “image ID” refers to an identifier uniquely specifying image data in the storage area for the image data 204.

In step Ss200, the CPU 202 determines whether the type of meta information T yet to be processed exists in the meta information generation request R. If the type of meta information T yet to be processed exists in the meta information generation request R (YES in step Ss200), the CPU 202 advances to step Ss201. If the type of meta information T yet to be processed does not exist in the meta information generation request R (NO in step Ss200), the CPU 202 ends the process illustrated in FIG. 9.

In step Ss201, the CPU 202 determines whether the image IDI of image data to which the meta information specified by the type of meta information T is not provided, exists in the storage area for the image data 204. If the image IDI of image data to which the meta information specified by the type of meta information T is not provided, exists in the storage area for the image data 204 (YES in step Ss201), the CPU 202 advances to step Ss202. If the image IDI of image data to which the meta information specified by the type of meta information T is not provided, does not exist in the storage area for the image data 204 (NO in step Ss201), the CPU 202 returns to Ss200.

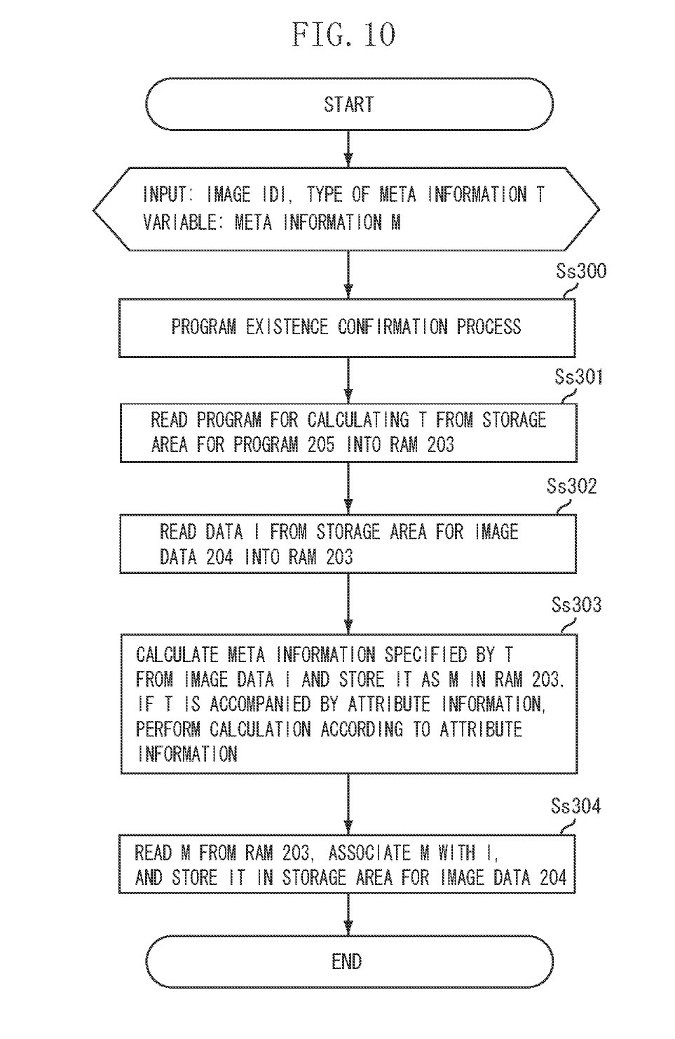

In step Ss202, the CPU 202 executes a meta information generation process illustrated in FIG. 10 (execution of meta information generation process).

FIG. 10 is a flow chart for a process executed in the communication apparatus for the photographing apparatus 200. The flow chart illustrates an example of the meta information generation process. The process describes step Ss202 in FIG. 9 in detail. In the present case, the meta information refers to a thumbnail image, facial information, or scene information, however, the present exemplary embodiment is not limited to those described above.

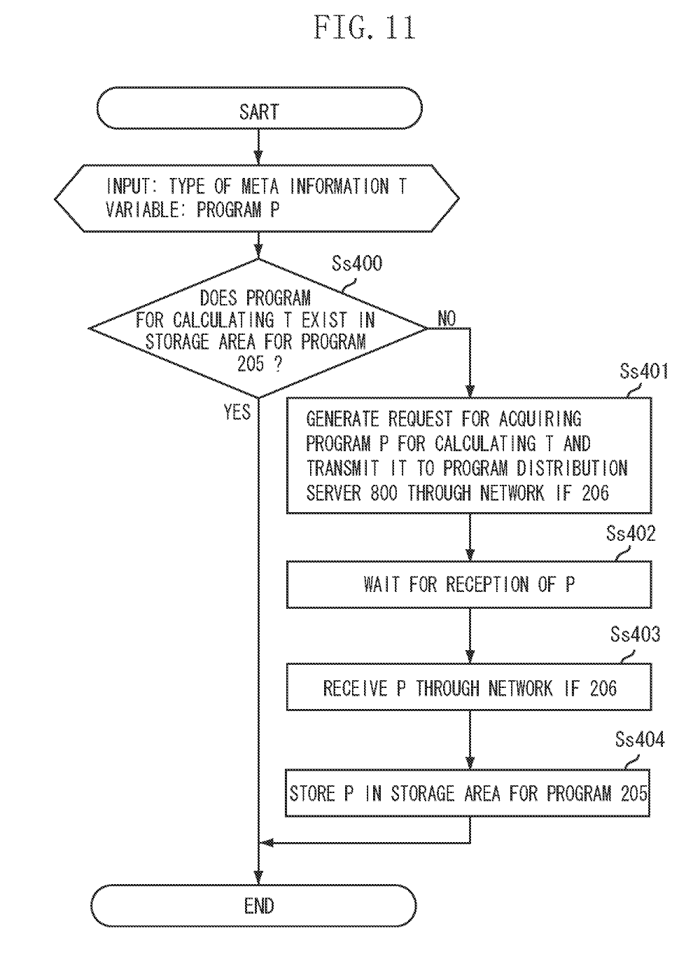

In step Ss300, the CPU 202 executes a program existence confirmation process. The details of the program existence confirmation process are described in FIG. 11.

In step Ss301, the CPU 202 reads a program for calculating the type of meta information T from the storage area for the program 205, into the RAM 203.

In step Ss302, the CPU 202 reads image data indicated by the image IDI from the storage area for the image data 204, into the RAM 203.

In step Ss303, the CPU 202 calculates the meta information specified by the type of meta information T from the image data indicated by I and stores it as the meta information M in the RAM 203. If the type of meta information T is accompanied by attribute information, the CPU 202 performs the calculation of the meta information M according to the attribute information.

If the meta information is a thumbnail image, for example, the CPU 202 calculates (generates) the thumbnail image of image size, image quality, image format, or color conversion parameter which are the attribute information, according to the image data.

If the meta information is facial information, the CPU 202 detects a facial area from the image data and checks the image of the detected facial area (facial image) against the previously registered facial information database to calculate (generate) the facial information.

If the meta information is scene information, the CPU 202 analyzes the image data to discriminate a scene therefrom and calculates (generates) the scene information.

In step Ss304, the CPU 202 reads the meta information M from the RAM 203, associates the meta information with I, and stores it in the storage area for the image data 204. In the present exemplary embodiment, the meta information M is associated with I in such a manner that the file storing the meta information except the extension is given the same name as the file of the image data, however, the present exemplary embodiment is not limited to that described above.

FIG. 11 is a flow chart for a process executed in the communication apparatus for the photographing apparatus 200 and illustrating an example of the program existence confirmation process. The process describes step Ss300 in FIG. 10 in detail. The program refers to byte data in which instructions that can be interpreted by the CPU 202, and constant values are arranged.

In step Ss400, the CPU 202 determines whether there is a program for calculating the type of meta information T in the storage area for the program 205. If there is a program for calculating the type of meta information T in the storage area for the program 205 (YES in step Ss400), the CPU 202 ends the process illustrated in FIG. 11. If there is no program for calculating the type of meta information T in the storage area for the program 205 (NO in step Ss400), the CPU 202 advances to step Ss401.

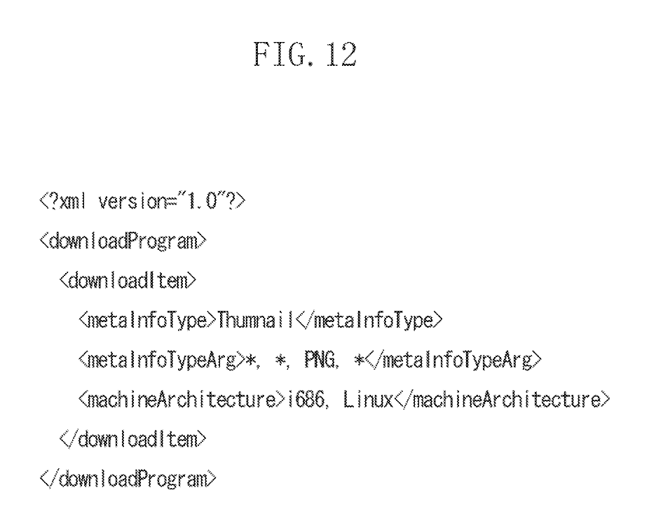

In step Ss401, the CPU 202 generates a request for acquiring a program P for calculating the type of meta information T and transmits the request for acquiring the program P to the program distribution server 800 through the network IF 206. The request for acquiring the program P is expressed in the XML format illustrated in FIG. 12. FIG. 12 illustrates an example of the request for acquiring the program P. As illustrated in FIG. 12, the request to acquire the program P describes the type of meta information, attribute information attached to the type of meta information, and the architecture of the CPU 202 and the type of an operating system (OS).

In step Ss402, the CPU 202 waits for reception of the program P.

In step Ss403, the CPU 202 receives the program P through the network IF 206.

In step Ss404, the CPU 202 stores the program P in the storage area for the program 205.

The communication apparatus for the photographing apparatus 200 executes the processes from Ss401 to Ss404 to download the program P from the program distribution server 800.

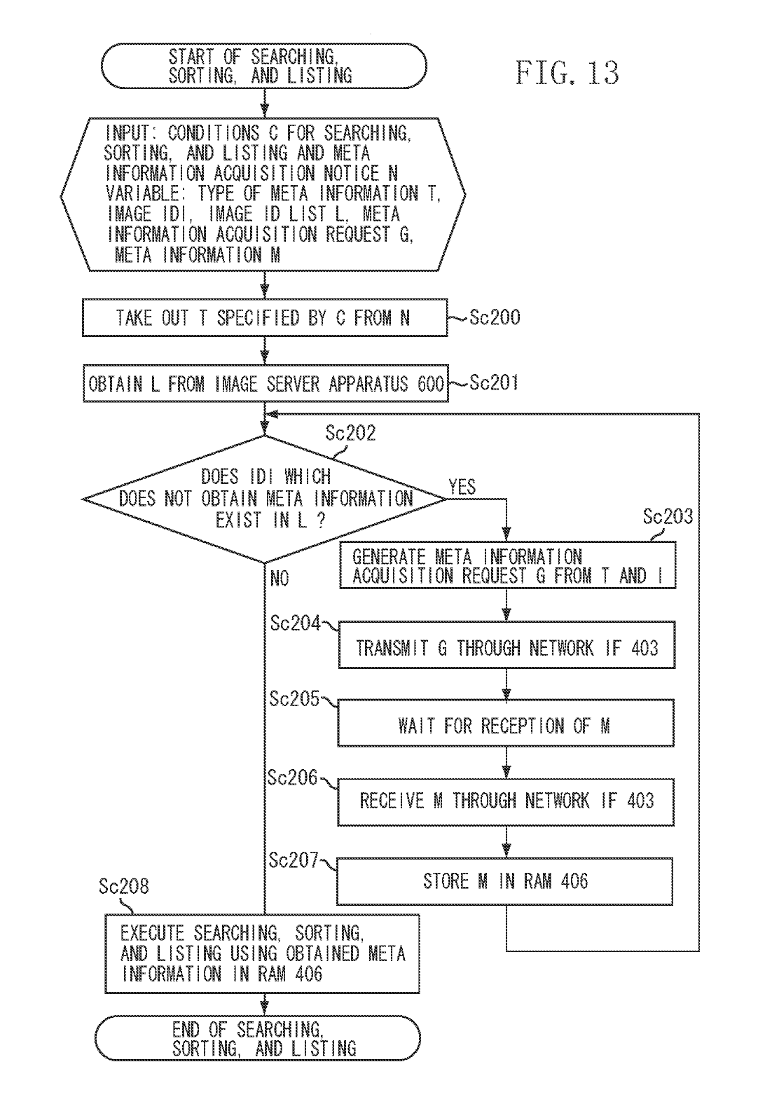

FIG. 13 is a flow chart for a process executed in the communication apparatus for the display apparatus 400. The flowchart illustrates an example of the process from the start to the end of searching, sorting, and listing. The process describes step Sc2 to Sc3 in FIG. 2 in detail. An image ID list shows in a list form the image ID for all the image data to be searched, sorted, and listed, among the data in the storage area for the image data 204.

In step Sc200, the CPU 405 extracts the type of meta information T specified by searching, sorting, and listing from the meta information acquisition notice N.

In step Sc201, the CPU 405 obtains the image ID list L from the image server apparatus 600.

In step Sc202, the CPU 405 determines whether the image IDI which has not obtained the meta information exists in the image ID list L. If the image IDI which has not obtained the meta information exists in the image ID list L (YES in step Sc202), the CPU 405 advances to Sc203. If the image IDI which has not obtained the meta information does not exist in the image ID list L (NO in step Sc202), the CPU 405 advances to Sc208.

In step Sc203, the CPU 405 generates the meta information acquisition request G from the type of meta information T and I (acquisition request generation).

In step Sc204, the CPU 405 transmits the meta information acquisition request G to the image server apparatus 600 through the network IF 403 (acquisition request transmission).

In step Sc205, the CPU 405 waits for reception of the meta information M.

In step Sc206, the CPU 405 receives the meta information M from the image server apparatus 600 through the network IF 403.

In step Sc207, the CPU 405 stores the meta information M in the RAM 406.

In step Sc208, the CPU 405 executes searching, sorting, and listing using the meta information M stored in the RAM 406.

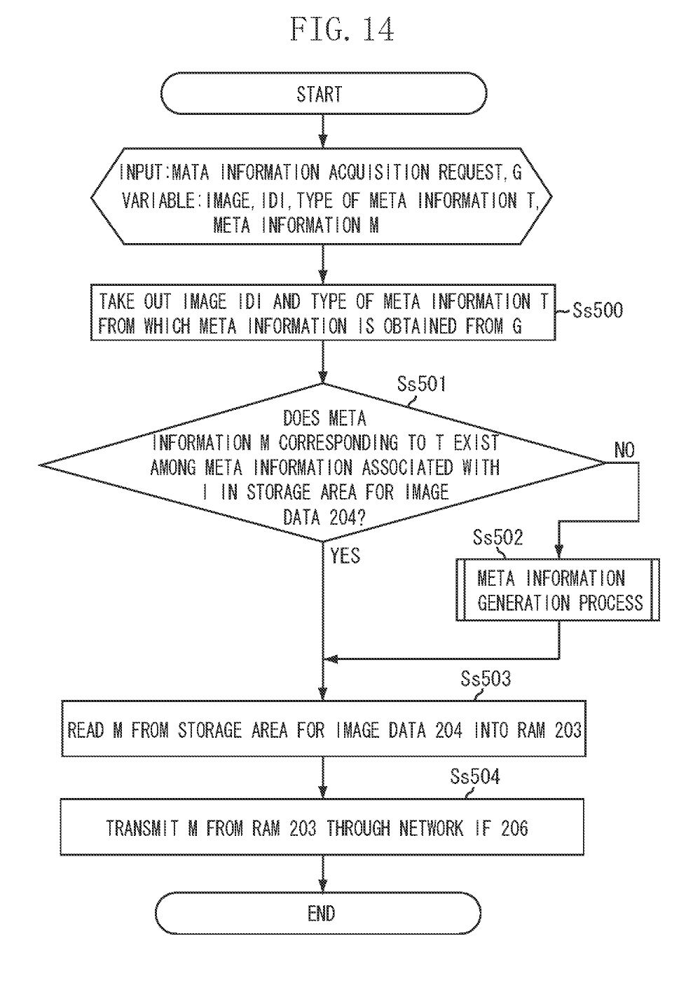

FIG. 14 is a flow chart for a process executed in the communication apparatus for the photographing apparatus 200. The flow chart illustrates an example of the meta information transmission process. The process describes step Ss4 in FIG. 2 in detail. The meta information transmission process (step Ss4 in FIG. 2) in response to the meta information acquisition request advances in parallel with the meta information generation process (steps Ss2 to Ss3 in FIG. 2) for the meta information acquisition notice, so that the meta information for the targeted image data may not be generated at the time of execution in step Ss501. For this reason, if the meta information is not yet generated, step Ss502 is executed to generate the meta information and transmit it.

In step Ss500, the CPU 202 extracts from the meta information acquisition request G, the image IDI and the type of the meta information T as to which the meta information is to be obtained.

In step Ss501, the CPU 202 determines whether among the meta information associated with I, the meta information M corresponding to the type of meta information T exists in the storage area for the image data 204. If among the meta information associated with I, the meta information M corresponding to the type of meta information T exists in the storage area for the image data 204 (YES in step Ss501), the CPU 202 advances to step Ss503. If among the meta information associated with I, the meta information M corresponding to the type of meta information T does not exist in the storage area for the image data 204 (NO in step Ss501), the CPU 202 advances to step Ss502.

In step Ss502, the CPU 202 executes the meta information generation process illustrated in FIG. 10.

In step Ss503, the CPU 202 reads the meta information M from the storage area for the image data 204 into the RAM 203.

In step Ss504, the CPU 202 transmits the meta information M from the RAM 203 to the image client apparatus 700 through the network IF 206.

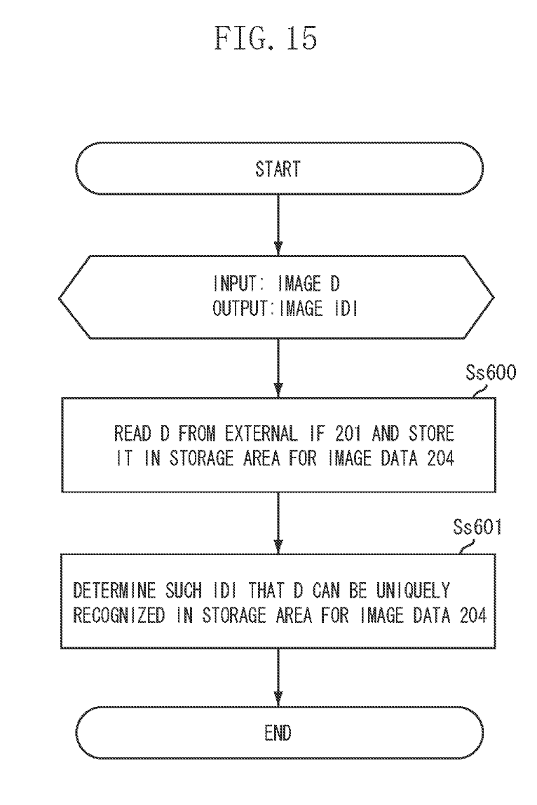

FIG. 15 is a flow chart for a process executed in the communication apparatus for the photographing apparatus 200. The flowchart illustrates an example of the process for storing new image data in a storage area. The process describes step Ss4 in FIG. 6 in detail. The image data refers to binary data in a joint photographic experts group (JPEG) or a moving picture experts group (MPEG) format. The present exemplary embodiment, however, is not limited to those image formats.

In step Ss600, the CPU 202 reads the image data D from the external IF 201 and stores the image data D in the storage area for the image data 204.

In step Ss601, the CPU 202 determines ID, the image IDI that the image data D can uniquely recognize in the storage area for the image data 204.

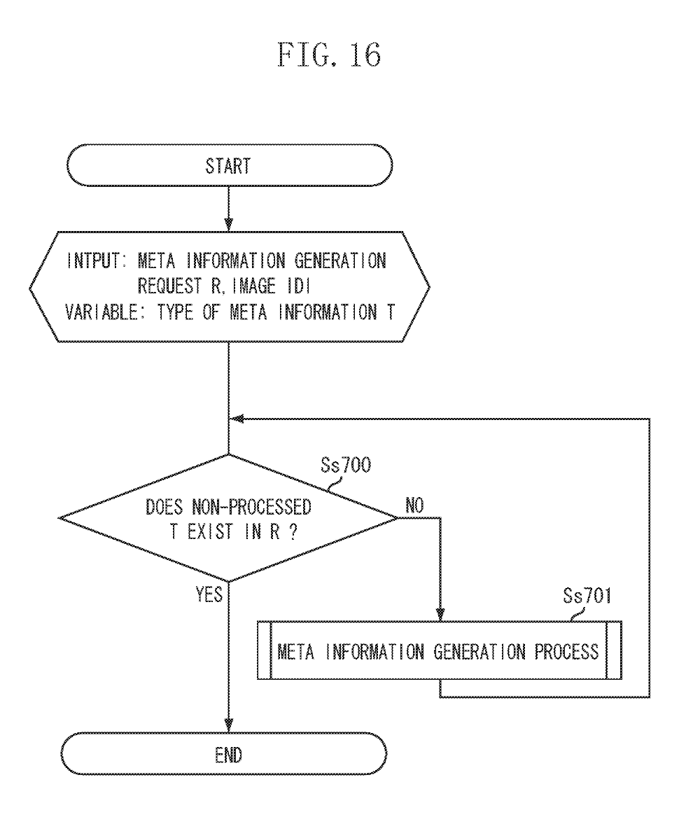

FIG. 16 is a flow chart for a process executed in the communication apparatus for the photographing apparatus 200. The flow chart illustrates an example of the meta information generation process for new image data. The process describes step Ss5 in FIG. 6 in detail.

In step Ss700, the CPU 202 determines whether the type of meta information T yet to be processed exists in the meta information generation request R. If the type of meta information T yet to be processed exists in the meta information generation request R (YES in step Ss700), the CPU 202 advances to step Ss701. If the type of meta information T yet to be processed does not exist in the meta information generation request R (NO in step Ss700), the CPU 202 ends the process illustrated in FIG. 16.

In step Ss701, the CPU 202 executes the process illustrated in FIG. 10.

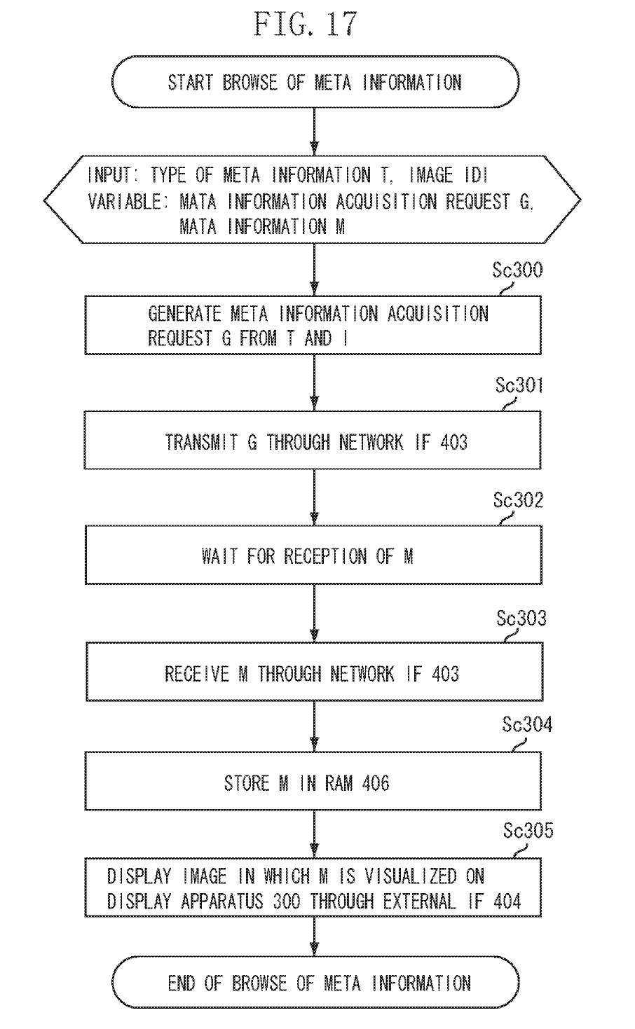

FIG. 17 is a flow chart for a process executed in the communication apparatus for the display apparatus 400. The process illustrates an example of the process from the start to the end of the browsing of meta information. The process describes steps Sc2 to Sc3 in FIG. 5 in detail.

In step Sc300, the CPU 405 generates the meta information acquisition request G from the type of meta information T and the image IDI.

In step Sc301, the CPU 405 transmits the meta information acquisition request G to the image server apparatus 600 through the network IF 403.

In step Sc302, the CPU 405 waits for reception of the meta information M.

In step Sc303, the CPU 405 receives the meta information M from the image server apparatus 600 through the network IF 403.

In step Sc304, the CPU 405 stores the meta information M in the RAM 406.

In step Sc305, the CPU 405 displays the image in which the meta information M is visualized on the display apparatus 300 through the external IF 404.

The image client apparatus 700 executes the processes from steps Sc300 to Sc305 to enable the user to browse the meta information.

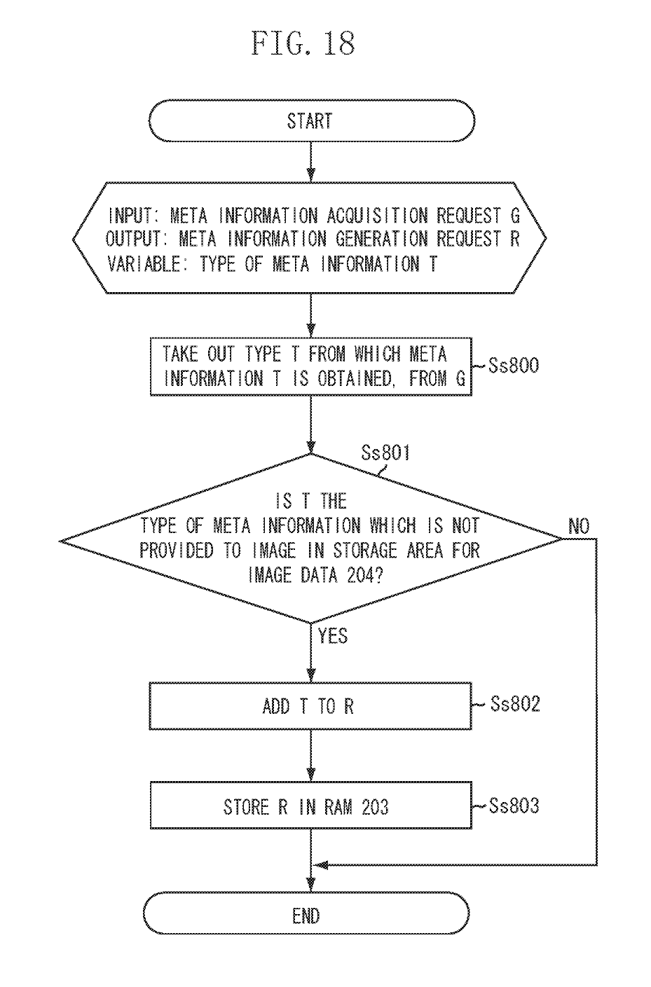

FIG. 18 is a flow chart for a process executed in the communication apparatus for the photographing apparatus 200. The flow chart illustrates an example of the process for storing a renewed meta information generation request. The process describes step Ss4 in FIG. 5 in detail.

In step Ss800, the CPU 202 extracts the type of meta information T from which meta information is to be obtained, from the meta information acquisition request G.

In step Ss801, the CPU 202 determines whether the type of meta information T is the type which is not provided to the image in the storage area for the image data 204. If the type of meta information T is the type which is not provided to the image in the storage area for the image data 204 (YES in step Ss801), the CPU 202 advances to Ss802. If the type of meta information T is the type which is provided to the image in the storage area for the image data 204 (NO in step Ss801), the CPU 202 ends the process illustrated in FIG. 18.

In step Ss802, the CPU 202 adds the type of meta information T to the meta information generation request R.

In step Ss803, the CPU 202 stores the meta information generation request R in the RAM 203.

The image server apparatus 600 performs the process illustrated in FIG. 18 to store the renewed meta information generation request R in the RAM 203 and the meta information generation process illustrated in FIG. 9 is started.

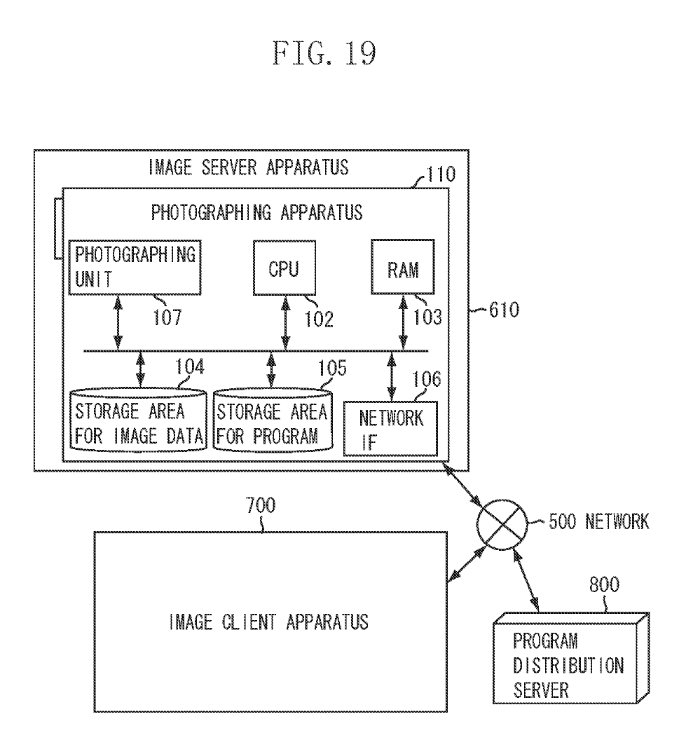

The image server apparatus may use a photographing apparatus including functions of the communication apparatus for the photographing apparatus described in the first exemplary embodiment. FIG. 19 is a block diagram illustrating an example of the system configuration of an image transmission and reception system and the hardware configuration of each apparatus forming the image transmission and reception system according to a second exemplary embodiment.

The present exemplary embodiment can be regarded as the one in which the function of the communication line 101 of the first exemplary embodiment in FIG. 1 is replaced with a wiring inside a photographing apparatus 110 in FIG. 19, therefore a detailed description is omitted.

The image server apparatus according to the claim is an image server apparatus 610 or a photographing apparatus 110, for example. The image client apparatus according to the claim is the image client apparatus 700 or the communication apparatus for the display apparatus 400, for example.

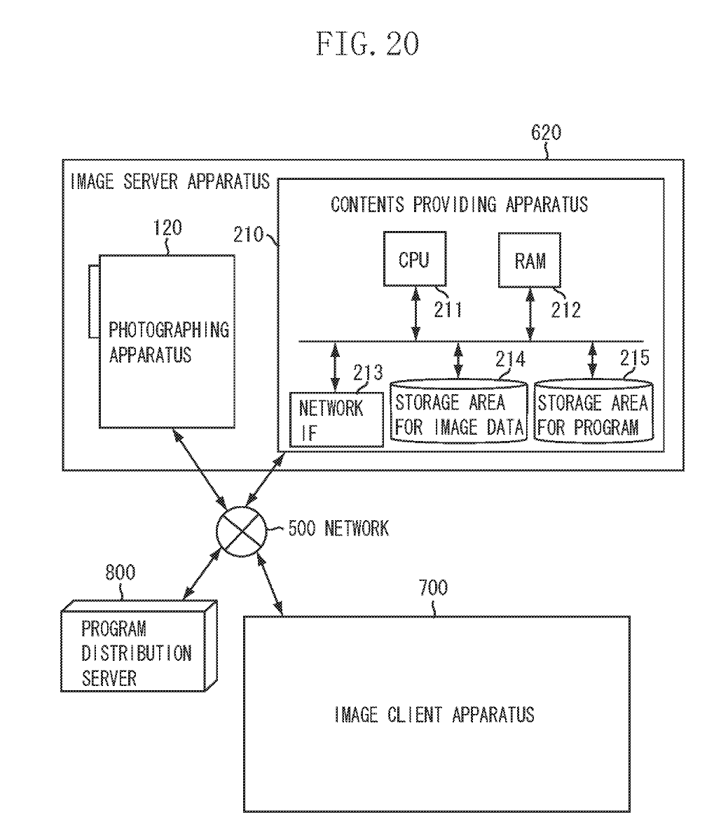

The present exemplary embodiment uses a combination of a photographing apparatus connectable to a network and a content providing apparatus having the function of the communication apparatus for the photographing apparatus described in the first exemplary embodiment as an image server apparatus. As is the case with the first exemplary embodiment, the present exemplary embodiment uses the communication apparatus for the display apparatus and the display apparatus connected thereto as an image client apparatus. FIG. 20 is a block diagram illustrating an example of the system configuration of an image transmission and reception system and the hardware configuration of each apparatus constituting the image transmission and reception system according to a third exemplary embodiment. The details of the image client apparatus are similar to those in FIG. 1, therefore the description thereof is omitted. Since the present exemplary embodiment can be regarded as the one in which the function of the communication line 101 of the first exemplary embodiment in FIG. 1 is replaced with the network 500, a detailed description is omitted.

The image server apparatus according to the claim is an image server apparatus 620 or a content providing apparatus 210, for example. The image client apparatus according to the claim is the image client apparatus 700 or the communication apparatus for the display apparatus 400, for example.

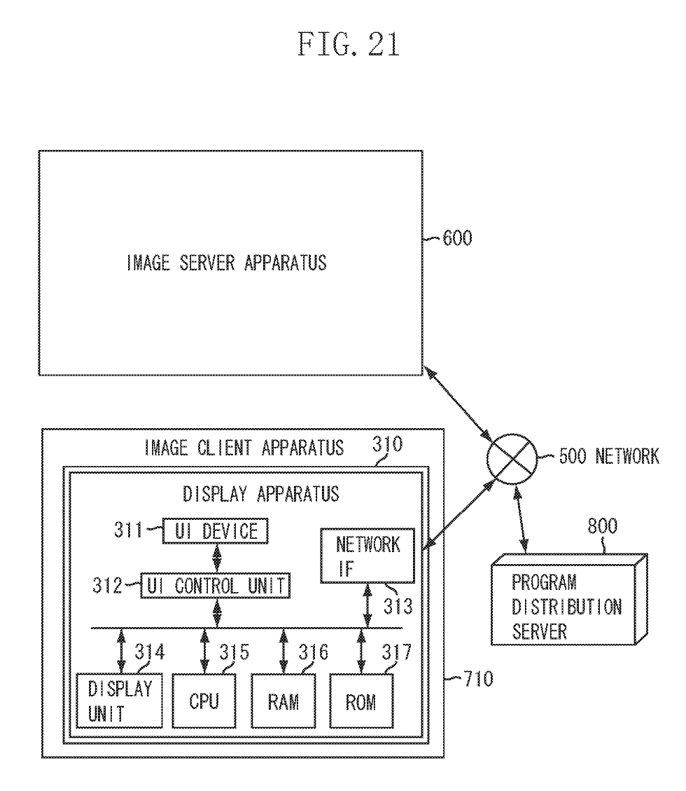

The present exemplary embodiment uses any of the image server apparatus described in the first to third exemplary embodiments and uses a display apparatus including the function of the communication apparatus for the display apparatus which is described in the first exemplary embodiment as the image client apparatus. FIG. 21 is a block diagram illustrating an example of the system configuration of an image transmission and reception system and the hardware configuration of each apparatus constituting the image transmission and reception system according to a fourth exemplary embodiment. The details of the image server apparatus are similar to any of those described in FIG. 1, 19, or 20, so that the description thereof is omitted.

The present exemplary embodiment can be regarded as the one in which the function of the communication line 301 of the first exemplary embodiment in FIG. 1 is replaced with a wiring inside a display apparatus 310 in FIG. 21, therefore a detailed description is omitted.

The image server apparatus according to the claim is the image server apparatus 600, for example. The image client apparatus according to the claim is a display apparatus 310, for example.

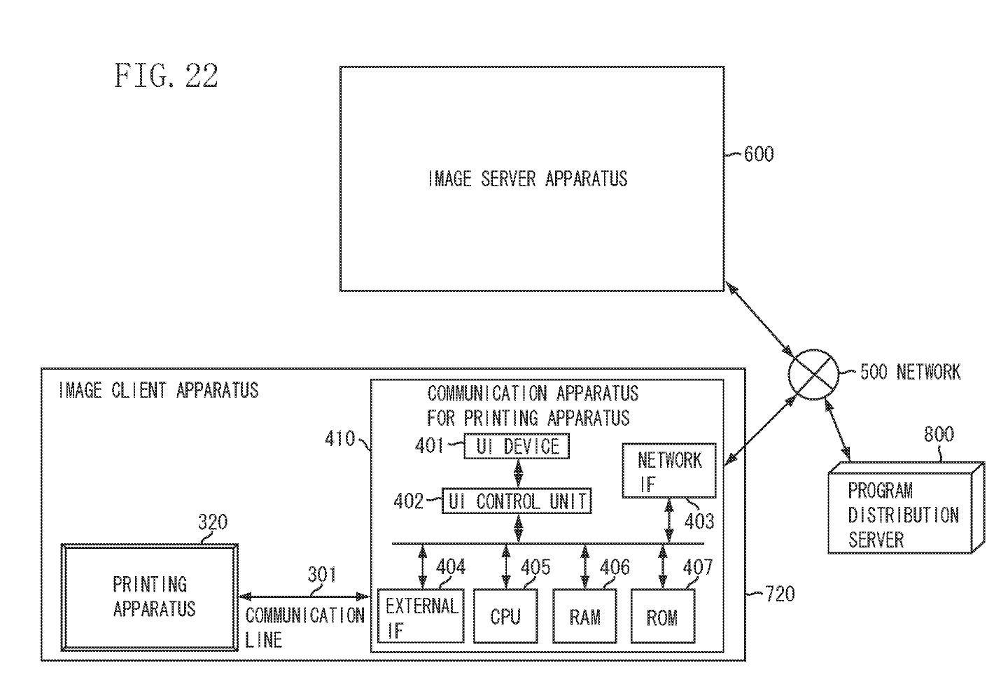

The present exemplary embodiment uses any of the image server apparatus described in the first to third exemplary embodiments and uses as the image client apparatus a communication apparatus for a printing apparatus having the same function as the communication apparatus for the display apparatus described in the first exemplary embodiment and a printing apparatus connected thereto. FIG. 22 is a block diagram illustrating an example of the system configuration of an image transmission and reception system and the hardware configuration of each apparatus constituting the image transmission and reception system according to a fifth exemplary embodiment. The details of the image server apparatus are similar to any of those described in FIG. 1, 19, or 20, so that the description thereof is omitted.

In present exemplary embodiment, image data sent from the image server apparatus 600 is output to the printing apparatus instead of the display apparatus. If the image data is a moving image, a head frame or a representative frame characterizing the image data is output to the printing apparatus.

The present exemplary embodiment can be regarded as the one in which the function of the display apparatus 300 of the first exemplary embodiment in FIG. 1 is replaced with the printing apparatus 320 in FIG. 22, therefore a detailed description is omitted.

The image server apparatus according to the claim is the image server apparatus 600, for example. The image client apparatus according to the claim is a communication apparatus 410 for a printing apparatus, for example.

If a printing apparatus including the function of the communication apparatus 410 for the printing apparatus is used as the image client apparatus, the printing apparatus can be formed as a single device. In this case, the function of the communication line 301 can be regarded as replaced with a wiring inside the printing apparatus, therefore a detailed description is omitted.

The image server apparatus according to the claim is the image server apparatus 600, for example. The image client apparatus according to the claim is the printing apparatus, for example.

The present exemplary embodiment uses an image server apparatus described in any of the first to fifth exemplary embodiments to which a meta information generation function with a new photographing function is added.

The term “meta information generation function with a new photographing function” refers to a meta information generation function which changes the photographing conditions of the connected photographing apparatus and generates the meta information from the image data obtained from new image capturing. Any of a pan angle, tilt angle, or angle of view, for example, is changed to change the photographing conditions. The meta information generation function is used in the case where the image data which can generate the type of meta information specified in the meta information acquisition notice does not exist in the storage area for the image data.

More specifically, The image server apparatus according to the present exemplary embodiment changes the photographing conditions of the photographing apparatus if the image data which is a base for the generation of the meta information requested from the image client apparatus is not stored in the storage area (the storage area for the image data). The image server apparatus according to the present exemplary embodiment generates the meta information based on the image data captured under the changed photographing conditions.

Thus, the meta information requested from the image client apparatus can be obtained in a more positive way.

According to the foregoing exemplary embodiments, the image server apparatus for supplying contents provides the meta information to enable reducing the compression of a communication band caused by the transmission of image data.

According to the foregoing exemplary embodiments, the meta information can be promptly returned in response to the meta information acquisition request from the image client apparatus to enable quickly presenting the result of searching, sorting, and listing to the user.

According to the foregoing exemplary embodiments, if the image server apparatus does not have a program for calculating the meta information, the program can be downloaded from the distribution server on the network to enable calculation.

According to the foregoing exemplary embodiments, an inexpensive image input apparatus (for example, a photographing apparatus) and the communication apparatus for the photographing apparatus, for example, are combined and used. Thus, a function to provide the advanced meta information which matches a request from the client apparatus, can be added even if the image input apparatus has an insufficient function to provide the meta information.

Until now, if the meta information is a thumbnail image, only a fixed size of 160×120, for example, has been provided, which has been inconvenient to display a list on a display apparatus with various resolutions like a large screen television or a cellular phone.

According to the foregoing exemplary embodiments, however, if the meta information is a thumbnail image, a thumbnail image with a thumbnail attribute requested by the client side can be calculated (or generated) on the server side and provided to the client side.

According to the foregoing exemplary embodiments, the server side can automatically generate the meta information requested by the client side.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-258539, filed Oct. 3, 2008 which is hereby incorporated by reference herein in its entirety.

What is claimed is:

1. An image server apparatus comprising:
a determination unit configured to determine whether there is image data to which meta information requested from an image client apparatus is not provided;
a generation unit configured to generate the meta information if there is image data to which the meta information is not provided as a result of the determination by the determination unit; and
a transmission unit configured to transmit the generated meta information to the image client apparatus.

2. The image server apparatus according to claim 1, further comprising:
a notice reception unit configured to receive a meta information acquisition notice including the type of meta information which may be requested by the image client apparatus, from the image client apparatus before transmitting information about image data to the image client apparatus; and
a storage unit configured to extract the type of meta information which is not provided to image data, from the meta information acquisition notice received by the notice reception unit and store the extracted type of meta information in a storage area as a meta information generation request.

3. The image server apparatus according to claim 2, further comprising:
a request reception unit configured to receive an acquisition request for meta information, from the image client apparatus after the transmission is started; and
an addition unit configured to add the type of the meta information to the meta information generation request if the type of meta information requested by the acquisition request received by the request reception unit is not included in the meta information generation request stored in the storage area.

4. The image server apparatus according to claim 2,
wherein the determination unit determines whether there is image data to which meta information requested from the image client apparatus is not provided, based on the meta information generation request stored in the storage area and the image data.

5. The image server apparatus according to claim 2,
wherein the generation unit determines whether there is a generation execution unit configured to generate the meta information requested by the image client apparatus, transmits an acquisition request for a program to realize the generation execution unit, to a program distribution server if there is no generation execution unit, receives the program from the program distribution server, and instructs the program to generate the meta information requested by the meta information generation request stored in the storage area.

6. The image server apparatus according to claim 2,
wherein the generation unit determines whether there is a generation execution unit configured to generate the meta information requested by the image client apparatus and instructs the generation execution unit to generate the meta information requested by the meta information generation request stored in the storage area if there is the generation execution unit.

7. The image server apparatus according to claim 1,
wherein the generation unit changes the photographing conditions of a photographing apparatus if the image data which is a base for the generation of meta information requested from the image client apparatus is not stored in the storage area and executes a process to generate the meta information based on the image data captured under the changed photographing conditions.

8. The image server apparatus according to claim 2,
wherein, when image data is stored, the generation unit instructs the generation execution unit configured to generate meta information, to generate the meta information requested by the meta information generation request stored in the storage area based on the image data.

9. The image server apparatus according to claim 2,
wherein, when the meta information generation request is stored in the storage area by the storage unit, the generation unit instructs a generation execution unit configured to generate meta information, to generate the meta information requested by the meta information generation request stored in the storage area, based on the image data.

10. An image client apparatus comprising:
a request generation unit configured to generate an acquisition request for meta information based on the type of meta information of image data;
a request transmission unit configured to transmit the acquisition request for meta information generated by the request generation unit, to an image server apparatus; and
a meta information reception unit configured to receive the meta information matching the acquisition request from the image server apparatus.

11. The image client apparatus according to claim 10, further comprising:
a notice generation unit configured to generate a meta information acquisition notice including the type of meta information which may be requested, based on the type of meta information of image data; and
a notice transmission unit configured to transmit the meta information acquisition notice generated by the notice generation unit to the image server apparatus before the request transmission unit transmits the acquisition request for the meta information to the image server apparatus.

12. An image transmission and reception system comprising an image server apparatus and an image client apparatus;
wherein the image client apparatus includes:
a request generation unit configured to generate an acquisition request for meta information based on the type of meta information of image data;
a request transmission unit configured to transmit the acquisition request for meta information generated by the acquisition request generation unit to the image server apparatus; and
a meta information reception unit configured to receive the meta information matching the acquisition request from the image server apparatus; and
wherein the image server apparatus includes:
a determination unit configured to determine whether there is the image data to which meta information requested from the image client apparatus is not provided;
a generation unit configured to execute the process for generating the meta information if there is the image data to which the meta information is not provided as a result of the determination by the determination unit; and
a meta information transmission unit configured to transmit the generated meta information to the image client apparatus.

13. An information processing method in an image server apparatus comprising:
determining whether there is image data to which meta information requested from an image client apparatus is not provided;
generating the meta information if there is the image data to which the meta information is not provided as a result of the determination; and
transmitting the generated meta information to the image client apparatus.

14. An information processing method in a mage client apparatus comprising:
generating an acquisition request for meta information based on the type of meta information of image data;
transmitting the generated acquisition request for meta information to an image server apparatus; and
receiving the meta information matching the acquisition request from the image server apparatus.

15. An information processing method in an image transmission and reception system comprising an image server apparatus and an image client apparatus, the information processing method in the image client apparatus comprising:
generating an acquisition request for meta information based on the type of meta information of image data;
transmitting the generated acquisition request for meta information to the image server apparatus; and
receiving the meta information matching the acquisition request from the image server apparatus; and
the information processing method in the image server apparatus comprising:
determining whether there is the image data to which meta information requested from the image client apparatus is not provided;
generating the meta information if there is the image data to which the meta information is not provided as a result of the determination; and
transmitting the generated meta information to the image client apparatus.

16. A computer-readable storage medium that stores a program for instructing a computer to implement an information processing method in an image server apparatus, the information processing method comprising:
determining whether there is image data to which meta information requested from an image client apparatus is not provided;
generating the meta information if there is the image data to which the meta information is not provided as a result of the determination; and
transmitting the generated meta information to the image client apparatus.

17. A computer-readable storage medium that stores a program for instructing a computer to implement an information processing method in a mage client apparatus, information processing method comprising:
generating an acquisition request for meta information based on the type of meta information of image data;
transmitting the generated acquisition request for meta information to an image server apparatus; and
receiving the meta information matching the acquisition request from the image server apparatus.
